(19) United States
(12) Patent Application Publication
(10) Pub. No.: US 2014/0067997 A1
(43) Pub. Date: Mar. 6, 2014

(54) DOWNLOADING CONTENT

(71) Applicant: MICROSOFT CORPORATION, Redmond, WA (US)

(72) Inventors: Ando Saabas, Tallinn (EE); Andre Karpistsenko, Tallinn (EE)

(73) Assignee: MICROSOFT CORPORATION, Redmond, WA (US)

(21) Appl. No.: 13/674,756

(22) Filed: Nov. 12, 2012

(30) Foreign Application Priority Data
Aug. 28, 2012 (GB) 1215279.9

(51) Int. Cl. G06F 15/16

(52) U.S. Cl. 709/217

(57) ABSTRACT

Method, user device and computer program product for downloading content to the user device, wherein the user device is associated with a user. User preferences for downloading content associated with interactions between the user and other users are automatically determined based on past behaviour of the user when interacting with the other users. It is determined that more than one item of content associated with at least one interaction between the user and at least one of the other users are to be downloaded to the user device. The items of content to be downloaded to the user device are prioritized based on the automatically determined user preferences, and then at least some of the items of content are downloaded to the user device according to the prioritization of the items of content.

### RELATED APPLICATION

This application claims priority under 35 USC 119 or 365 to Great Britain Application No. 1215279.9 filed 28 Aug. 2012, the disclosure of which is incorporated in its entirety.

### BACKGROUND

A user can access content via a network (for example, the Internet or a telephone network) by downloading the content to a user device of the user. The user device may for example be a mobile phone, a tablet, a laptop, a personal computer (“PC”), a gaming device, a television, a personal digital assistant (“PDA”) or other embedded device able to connect to the network. The downloaded content may be used by one or more of a number of different applications which may be executed at the user device. The content may for example, be a message for the user, such as a text message, an audio message or a video message. The content may comprise data files e.g. to be stored at the user device. An item of content may be downloaded to the user device using a communication client implemented at the user device. The content may be downloaded from a communication client of another user in a communication system. Alternatively, the content may be downloaded from a server (such as an e-mail server or some other server in the network).

The order in which items of content (e.g. messages or files) are downloaded to the user device may vary arbitrarily, or may be determined by the respective timestamps of the items of content.

Traffic shaping, or QoS (“Quality of Service”) techniques may be used in routers to prioritize network traffic. Shaping can happen both on the Internet service provider side and locally, on the user's router or computer. When traffic shaping is applied, data packets carrying content with higher priority get preferential treatment over data packets carrying lower priority content. Better bandwidth and/or latency (i.e. higher bandwidth and lower latency) for higher priority traffic may be achieved by delaying or even dropping data packets carrying lower priority content. In a local router implemented at a user device, prioritisation of content may be based on the MAC address, Ethernet port or TCP/IP port of the downloaded content. This may allow certain equipment or applications implemented at the user device to have higher priority than others. For example, data being received at an Ethernet port to which a Voice Over Internet Protocol (VoIP) phone is connected to may get a “high” priority; whilst data being received at Transmission Control Protocol/Internet Protocol (TCP/IP) ports 80 and 443 may get a “medium” priority for web traffic; and the file server may get a “low” priority to download data files to the user device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

There is provided a method of downloading content to a user device, wherein the user device is associated with a user. User preferences for downloading content associated with interactions between the user and other users are automatically determined based on past behaviour of the user when interacting with the other users. It is determined that more than one item of content associated with at least one interaction between the user and at least one of the other users are to be downloaded to the user device. The items of content to be downloaded to the user device are prioritized based on the automatically determined user preferences, and then at least some of the items of content are downloaded to the user device according to the prioritization of the items of content.

The user's past behaviour (e.g. concerning interactions with other users) is used to prioritize the downloading of items of content to the user device.

### BRIEF DESCRIPTION OF THE DRAWINGS

For a better understanding of the described embodiments and to show how the same may be put into effect, reference will now be made, by way of example, to the following drawings in which:

FIG. 1 shows a communication system including two user devices;

FIG. 2 shows a schematic view of a user device; and

FIG. 3 is a flow chart for a process of downloading content to a user device.

### DETAILED DESCRIPTION

Methods are described herein in which download priorities are based on a user's past behaviour and preferences. That is, the items of content which are most likely to be relevant to the user, are downloaded first.

Methods described herein allow a user's data plan usage to be minimized and/or allow access to more important content faster. This can be achieved by ordering downloading of items of content according to the relevance of the items of content to the user. The relevancy is determined by the user's past behaviour and/or may be predefined as priorities within and across network consuming applications.

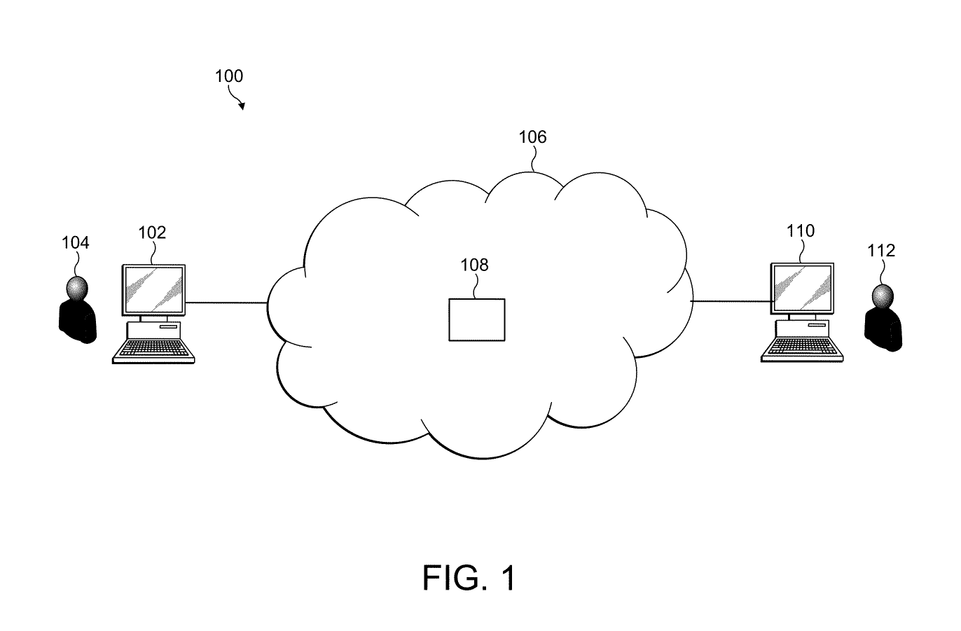

FIG. 1 shows a communication system 100 comprising a first user 104 who is associated with a first user device 102 and a second user 112 who is associated with a second user device 110. In other embodiments the communication system 100 may comprise any number of users and associated user devices. The user devices 102 and 110 can communicate over the network 106 in the communication system 100, thereby allowing the users 104 and 112 to communicate with each other over the network 106. The communication system 100 includes at least one server 108 in the network 106, although in some embodiments a server is not needed in the communication system. The communication system 100 shown in FIG. 1 is a packet-based communication system, but other types of communication system could be used. The network 106 may, for example, be the Internet or a telephone network. Each of the user devices 102 and 110 may be, for example, a mobile phone, a tablet, a laptop, a personal computer (“PC”) (including, for example, Windows™, Mac OS™ and Linux™ PCs), a gaming device, a television, a personal digital assistant (“PDA”) or other embedded device able to connect to the network 106. The user device 102 is arranged to receive information from and output information to the user 104 of the user device 102. The user device 102 comprises output means such as a display and speakers. The user device 102 also comprises input means such as a keypad, a touch-screen, a microphone for receiving audio signals and/or a camera for capturing images of a video signal. The user device 102 is connected to the network 106.

The user device 102 executes an instance of a communication client, provided by a software provider associated with the communication system 100. The communication client is a software program executed on a local processor in the user device 102. The client performs the processing required at the user device 102 in order for the user device 102 to transmit and receive data over the communication system 100.

The user device 110 corresponds to the user device 102 and executes, on a local processor, a communication client which corresponds to the communication client executed at the user device 102. The user devices 102 and 110 are endpoints in the communication system 100. FIG. 1 shows only two users (104 and 112) and two associated user devices (102 and 110) for clarity, but many more users and user devices may be included in the communication system 100, and may communicate over the communication system 100 using respective communication clients executed on the respective user devices.

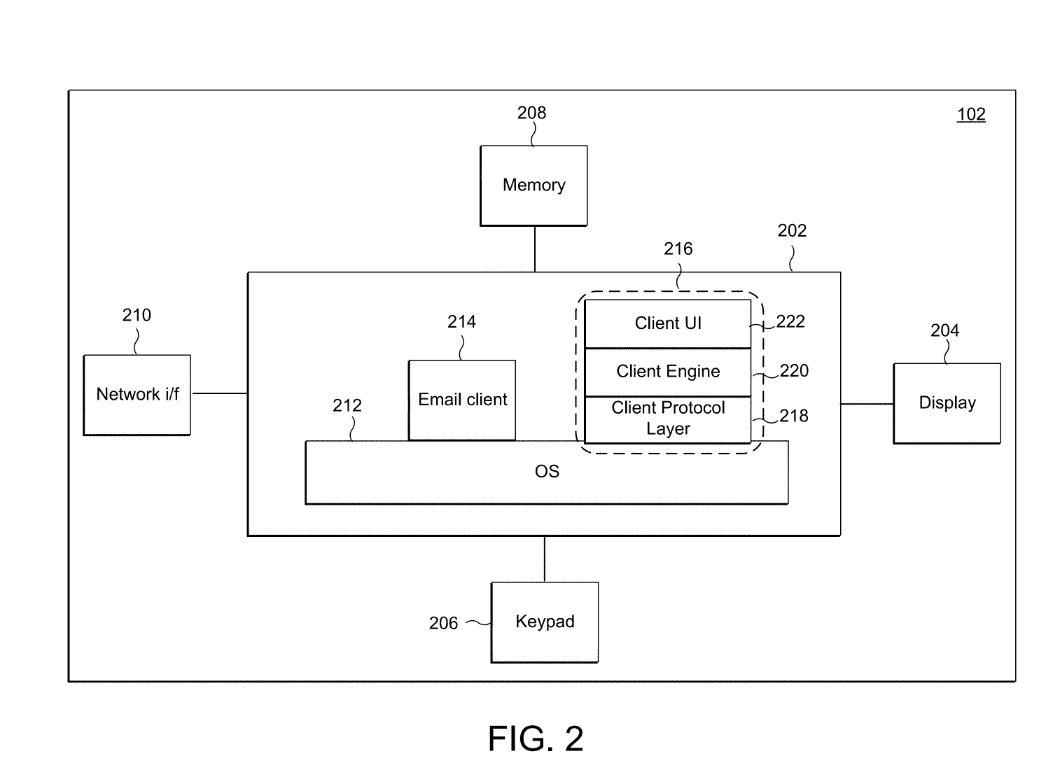

FIG. 2 illustrates a detailed view of the user device 102 on which is executed a communication client instance for communicating over the communication system 100. The user device 102 comprises a central processing unit (“CPU”) or “processing module” 202, to which is connected: output devices such as a display 204, which may be implemented as a touch-screen; input devices such as a keypad 206; a memory 208 for storing data; and a network interface 210 such as a modem for communication with the network 106. The user device 102 may comprise other elements than those shown in FIG. 2. The display 204, keypad 206, memory 208 and network interface 210 may be integrated into the user device 102 as shown in FIG. 2. In alternative user devices one or more of the display 204, the keypad 206, the memory 208 and the network interface 210 may not be integrated into the user device 102 and may be connected to the CPU 202 via respective interfaces. One example of such an interface is a USB interface. If the connection of the user device 102 to the network 106 via the network interface 210 is a wireless connection then the network interface 210 may include an antenna for wirelessly transmitting signals to the network 106 and wirelessly receiving signals from the network 106.

FIG. 2 also illustrates an operating system (“OS”) 212 executed on the CPU 202. Running on top of the OS 212 is an email client application 214. The email client application 214 is implemented at the user device 102 to provide email functionality at the user device 102 for the user 104. Also running on top of the OS 212 is a software stack 216 for the client software of a client instance of the communication system 100. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 212 manages the hardware resources of the computer and handles data being transmitted to and from the network 106 via the network interface 210. The client protocol layer 218 of the client software communicates with the operating system 212 and manages the connections over the communication system. Processes requiring higher level processing are passed to the client engine layer 220. The client engine 220 also communicates with the client user interface layer 222. The client engine 220 may be arranged to control the client user interface layer 222 to present information to the user 104 via the user interface of the client and to receive information from the user 104 via the user interface.

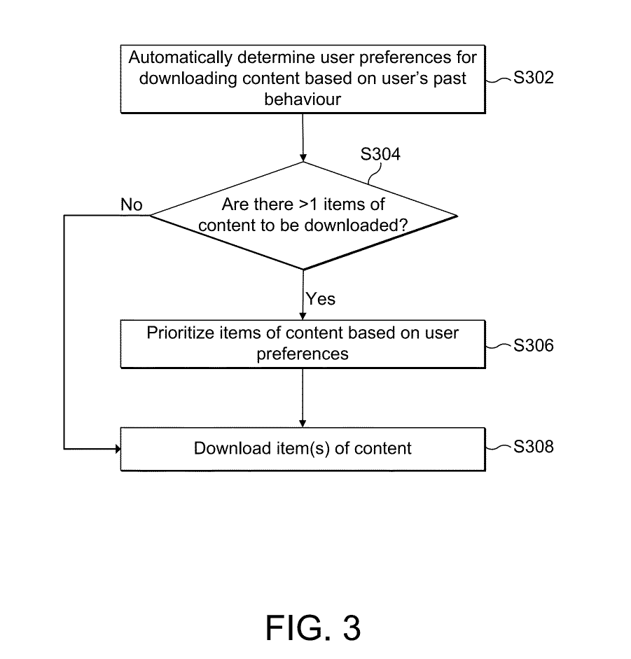

With reference to the flow chart shown in FIG. 3 there is now described a method of downloading content to the user device 102.

In step S302 user preferences of the user 104 for downloading content to the user device are automatically determined (e.g. by the communication client implemented at the user device 102). The user preferences are determined based on the past behaviour of the user 104. For example, where items of content to be downloaded relate to an interaction between the user 102 and the user 112 (e.g. when the content is a message sent from the user device 110 by the user 112 to the user device 102 for the user 104) then the user preferences for downloading the content may be determined based on how the user 104 has previously interacted with the user 112 and with other users in the communication system. Some examples of how the user preferences may be determined are described in more detail below.

In step S304, when an item of content is to be downloaded to the user device 102, it is determined (e.g. by the user device 102 or by the server 108) whether there is more than one item of content to be downloaded to the user device 102. For example, if the user 104 uses the email client application 214 to check an inbox of an email account of the user 104 then there may be a plurality of email messages which are new to the inbox and which are to be downloaded to the user device 102 for the user to view. Each of these new messages can be downloaded to the email client application 214 at the user device 102 as a separate item of content, each of which may be assigned a respective download priority as described below.

If there is currently only one item of content to be downloaded to the user device 102 then the method passes from step S304 to step S308 in which the item of content is downloaded to the user device 102.

However, if there are multiple items of content to download to the user device 102 then it may be beneficial to first download the items of content which are most relevant to the user 104. Therefore, if in step S304 it is determined that there are multiple items of content (e.g. multiple unread messages in an inbox of the user 104) to be downloaded to the user device 102 then the method passes from step S304 to step S306.

In step S306 the items of content to be downloaded to the user device 102 are prioritized based on the user preferences determined in step S302.

In step S308, following the prioritization of the items of content in step S306, the items of content are downloaded according to the prioritization of the items of content. In this way the items of content are downloaded to the user device 102 in priority order, with the most relevant/important items of content being downloaded first. That is, higher priority items of content are downloaded ahead of lower priority items of content. This may be beneficial because in some cases it may not be possible, or desirable, to download all of the items of content to the user device 102, e.g. if there is congestion on the network 106 or if the user pays for downloading data based on the amount of data downloaded to the user device 102.

It may be that in step S308 all of the items of content to be downloaded to the user device 102 are in fact downloaded to the user device 102. However, it may be that in step S308 only some (not all) of the items of content to be downloaded to the user device 102 are downloaded to the user device 102 (e.g. if the network connection is slow or inadequate to download all of the items of content).

The ordering of the items of content is performed based on the past behaviour of the user 104. That is, the past behaviour of the user 104 is used to learn the user's preferences for downloading content. This allows the communication client at the user device 102 (or the server 108) to automatically infer which content is most important to the user 104. This is achieved without the user 104 being required to manually set the user preferences for downloading content.

There are described below some examples of how the user preferences for downloading content may be automatically determined based on the user's past behaviour.

When more than one application implemented at the user device 102 (e.g. the email client application 214 and the communication client 216) attempts to download content, there are provided herein methods for ranking and prioritization of the applications for the use of data based on the user's past interaction with the applications. The ranking may include ranking across different applications based on the user's interaction with the different applications. The ranking may additionally or alternatively include content based sub-ranking within a single application. For example, the most frequently used email accounts setup in the user device 102 may be given priority for downloading new emails over other email accounts. Furthermore, within each email account, messages may be downloaded to the user device 102 in order of priority, (decided based on user preference/past interactions) with higher priority messages being downloaded before lower priority messages.

In one example, the communication client 216 implemented at the user device 102 ranks other users and/or communication events based on interactions of the user 104 with the other users in the communication events. These ranks (or “scores”) can be used to determine the priorities for downloading content relating to a subsequent interaction of the user 104 with the other users in subsequent communication events. The interactions between the user 104 and the other users may be communication events (or “conversations”) over the communication system 100 or over some other communication system. The other users with whom the user 104 interacts with may be “contacts” of the user 104 in the communication system 100 and may for example include the user 112.

The communication client 216 may calculate the priority (i.e. the “ranks” or “scores”) using one or more of the following metrics:

1. Based on activity of the user 104 in communication events. Communication events in which the user 104 has actively participated in the past (e.g. active chats in the communication system 100, active e-mail threads in the e-mail client application 214) are more relevant than communication events in which the user 104 does not participate. The score (or “rank”) calculation for a contact and/or communication event may be performed in the following way:
Initially, the rank of each contact and communication event is 0
For each communication event (message, email, call, etc) between the user 104 and a contact (e.g. user 112) in which the user 104 actively participates (e.g. each communication event that is initiated by the user 104), the rank of the contact and/or communication event is increased. The amount of the increase depends on the type of the communication event, e.g. the medium of the communication event—a video call is more important than a text message, and so the amount of the increase is larger for a video call than for a text message. The amount of the increase also depends upon the number of participants of the communication event, e.g. personal messages are more important than messages to a large audience, i.e. messages which have a large number of recipients. For example, “read-only” multichat messages (which have a large number of recipients) have lower priority than personal chats (e.g. between only the user 104 and the user 112) that the user 104 actively contributes to.
The ranks decay in time, so that more recent communication events are more relevant than older communication events in terms of determining the priorities.
   2. Based on response speed of the user 104. The communication events and contacts that get a response faster from the user 104 on average are ranked higher. A fast response from the user 104 indicates that the communication event is important to the user 104.
   3. Based on unexpectedness of a communication event. For example, a message from an authorized contact of the user 104 who seldom sends a message to the user 104 should get a higher priority than messages from contacts who send messages very often to the user 104. This in some sense contradicts activity based ranking, but is mostly meant to distinguish between “read-only” messages where the ranks would otherwise be equal.
   4. Based on size of the items of content. Using this metric, if items of content have similar ranks in other measures, the items of content that are smaller in size are downloaded first. This is particularly useful in a scenario in which not all of the items of content are able to be downloaded so that a complete smaller item of content may be downloaded rather than downloading only part of a larger item of content.

The ranks are calculated in a fully online fashion, meaning that the ranks are kept up to date in a continuous fashion without doing any recomputation on already processed events. The ranks may be stored in a data store, e.g. in the memory 208 at the user device 102 or in a memory of the server 108. Each time a new communication event occurs, the ranks are updated to take account of the new communication event. By keeping the ranks stored in the data store up to date, when the ranks are needed in order to prioritize items of content for downloading to the user device 102, the ranks have already been computed and all that is required is to retrieve the ranks from the data store to determine the user preferences for downloading content (in step S302). This allows the user preferences to be automatically determined quickly in step S302 when they are needed, without the need to recompute the ranks at that time. The user preferences for downloading content to the user device 102 are dynamically determined. In other words, the user preferences for downloading content to the user device 102 are determined in real-time.

Content downloading or “synchronization” can happen in one of two ways described here. Either a “pull” architecture is implemented in which the user device 102 (e.g. the client 216 running on the user device 102) initiates the downloading of content, or a “push” architecture is implemented in which content is sent to the user device 102 by the server 108 or by other clients (e.g. a client running on the user device 110), without being directly requested by the user device 102. In the pull scenario it suffices to compute the prioritization for the downloading of content only on the client side (i.e. at the user device 102), since it is always the client at the user device 102 which decides what and when to download to the user device 102. In the push scenario, the pushing party needs to be aware of the client side's priorities. This is straightforward in a client-server side architecture, since the server has the full history of the chat activity and thus can compute the priorities for the user 104 of the user device 102.

As described above, the user preferences (e.g. ranks) for downloading content to the user device 102 may be based on past behaviour of the user 104 when interacting with other users (e.g. user 112). For example, when downloading multiple message from a mailbox of the user 104, the order of downloading the messages is determined as described herein in accordance with the importance/relevance of the messages to the user 104, which may, or may not, be different to the order in which the messages are displayed in the inbox (which is typically in date order).

In one example, a purely peer-to-peer (P2P) based system is implemented which does not require servers to be implemented in the network 106. To download content from peers, the client 216 executed at the user device 102 contacts each connected client of the respective peers (or “contacts”). If for example, users B and C (not shown in FIG. 1) are contacts of the user 104 in the communication system, the user 104 may log into the communication system 100 (e.g. using the client 216) and may wish to download content (e.g. messages) from respective communication clients associated with the users B and C. In an example, user B is an important contact for user 104 (based on the ranks calculated based on previous interactions, e.g. communication events, between user 104 and user B), but user C is an unimportant contact for user 104 (based on the ranks calculated based on previous interactions, e.g. communication events, between user 104 and user C). In this example, the content for download to the user device 102 from the user B will be prioritized ahead of the content for download to the user device 102 from the user C. Therefore the communication client 216 will contact the client for user B to download content therefrom first and then subsequently contact the client for user C to download content therefrom.

Similar methods to those described above may be used to prioritize the downloading of content across different applications.

In particular, there may be provided a method of downloading content to the user device 102, wherein the method comprises:
automatically determining user preferences for downloading content associated with different applications implemented at the user device 102, based on past behaviour of the user 104 when downloading content for the different applications;
determining that items of content associated with at least two applications implemented at the user device 102 are to be downloaded to the user device 102;
prioritizing the items of content to be downloaded to the user device 102 based on the automatically determined user preferences; and
downloading at least some of the items of content to the user device 102 according to the prioritization of the items of content.

Therefore, techniques analogous to those described in previous sections can be used to prioritize downloads across different applications at the user device 102, not just within one application. If multiple applications executed at the user device 102 are using the network 106 for downloading content, (such as the email client application 214 and a web browser) it may be beneficial if the download rate could be prioritized according to the relevance of the content for the user 104. For example, the bandwidth for the email client application 214 may be reduced while a web browser is engaged in user-initiated webpage download. Once a (higher priority) process has finished, the bandwidths are renegotiated. A BitTorrent client application is another application which may be implemented at the user device 104. The Bit Torrent client application can be used to control the downloading of files over the network 106 to the user device 104.

The ranks (or priorities) may be learned based on usage patterns of different applications at the user device 102. For example, if the user manually changes the download rate of a first network-accessing application (e.g. the BitTorrent client application) before accessing the network 106 using a second network-accessing application (e.g. before web surfing in a web session via the web browser), and then manually changes the download rate of the first network-accessing application back later after the second network-accessing application has finished accessing the network 106, this behaviour of the user 104 can be learned so that subsequently the download rate changes are applied automatically. For example, the next time a web session is initiated in the web browser whilst the BitTorrent client application is implemented, the download rate (i.e. priority) of the BitTorrent client application is automatically lowered during the web session, and automatically raised again after the web session has finished. In this way the user device 102 learns the user preferences of the user 104 from the past behaviour of the user 104 and applies those user preferences to prioritize (e.g. order) the download of content in subsequent similar scenarios.

Prioritization of application network usage is an operating system level function. Automatically discovering network usage preferences (as in the example described above), assumes that user activity, as well as resource usage metrics are logged as time-series in the user device 102 and reoccurring patterns are discovered using a separate process.

Advantageously, according to methods described herein, the user preferences are determined automatically. This is beneficial compared to a router based traffic shaping scenario, in which the setup is relatively rigid and static, and in which the settings (or user “preferences”) are applied “once and for all” either by using presets or by the user manually changing them. The router based traffic shaping scenario requires manual intervention from the user to modify the download settings. Furthermore, the router based traffic shaping scenario does not allow prioritization within an application (like prioritizing the download of one message over the other).

Advantageously, in methods described herein download priorities are used within an application for the download of different items of content. Furthermore, the relative priorities of applications sharing the download link may be taken into account in order to determine the download priorities.

The prioritization may be dynamic, based on the user's past behaviour and preferences (both of which can change in time). The prioritization may apply to different items of content within an application as well as across applications.

By ordering content download according to a user's preferences, the user gets access to the most important content first. This may be particularly important when a network connection is slow or working inadequately. In a use case when the user is on a per-megabyte data plan and the user checks for an important message, he/she is more likely to get the important items first, and can cancel the connection without having to wait for all the synchronization to finish, therefore minimizing the download costs.

The methods described herein as illustrated by the steps shown in FIG. 3 may be implemented in hardware or in software executed on the processor 202. When the methods are implemented in software, they may be provided by way of a computer program product embodied on a tangible computer-readable hardware storage medium which is configured so as when executed on the processor 202 to perform the operations of the methods described herein. A computer-readable hardware storage medium is intended to cover all statutory forms of media and thus excludes non-statutory subject matter, e.g., carrier waves and signals per se.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of downloading content to a user device, the user device being associated with a user, the method comprising:
automatically determining user preferences for downloading content associated with interactions between the user and other users, based on past behaviour of the user when interacting with the other users;
determining that more than one item of content associated with at least one interaction between the user and at least one of said other users are to be downloaded to the user device;
prioritizing the items of content to be downloaded to the user device based on the automatically determined user preferences; and
downloading at least some of the items of content to the user device according to the prioritization of the items of content.

2. The method of claim 1 wherein the interactions are communication events between the user and the other users.

3. The method of claim 1 wherein said determining user preferences comprises determining a score for each of said other users that the user has interacted with and/or for each of a plurality of communication events that the user has participated in, wherein the scores indicate a priority for downloading content associated with the respective other users and/or communication events.

4. The method of claim 3 wherein for each communication event in which the user participates with one of said other users, the score for the respective other user and/or communication event is increased.

5. The method of claim 4 wherein the amount by which the score for the respective other user and/or communication event is increased is dependent upon at least one of: (i) the type of the communication event, (ii) the number of participants in the communication event, (iii) the speed with which the user responds in the communication event, and (iv) how expected the communication event is.

6. The method of claim 3 wherein the scores decay over time.

7. The method of claim 3 wherein the scores are stored in a data store and are kept up to date as communication events occur.

8. The method of claim 1 wherein said determining user preferences comprises determining the frequency with which different email accounts are used by the user, wherein content associated with more frequently used email accounts is given a higher priority.

9. The method of claim 1 wherein the user preferences are dynamically determined.

10. The method of claim 1 wherein said prioritizing the items of content to be downloaded to the user device is further based on the size of the items of content to be downloaded.

11. The method of claim 1 wherein the at least some of the items of content are downloaded to the user device from another user device associated with one of said other users.

12. The method of claim 1 wherein the at least some of the items of content are downloaded to the user device from a server.

13. The method of claim 1 wherein said downloading at least some of the items of content to the user device comprises downloading all of the items of content to the user device.

14. The method of claim 1 wherein said downloading at least some of the items of content to the user device comprises downloading some, but not all, of the items of content to the user device according to the prioritization of the items of content.

15. The method of claim 1 wherein said content comprises at least one of: a text message, an audio message, a video message and a data file.

16. A user device associated with a user, the user device being configured to download content by implementing a method comprising:
automatically determining user preferences for downloading content associated with interactions between the user and other users, based on past behaviour of the user when interacting with the other users;
determining that more than one item of content associated with at least one interaction between the user and at least one of said other users are to be downloaded to the user device;
prioritizing the items of content to be downloaded to the user device based on the automatically determined user preferences; and
downloading at least some of the items of content to the user device according to the prioritization of the items of content.

17. The user device of claim 16 comprising a data store for storing the determined user preferences.

18. The user device of claim 17 wherein the user device is configured to keep the user preferences stored in the data store up to date as communication events occur.

19. The user device of claim 16 wherein the interactions are communication events between the user and the other users.

20. A computer program product configured to download content to a user device, the user device being associated with a user, the computer program product being embodied on a tangible computer-readable hardware storage medium and configured so as when executed on a processor of the user device to perform the operations of:
automatically determining user preferences for downloading content associated with interactions between the user and other users, based on past behaviour of the user when interacting with the other users;
determining that more than one item of content associated with at least one interaction between the user and at least one of said other users are to be downloaded to the user device;
prioritizing the items of content to be downloaded to the user device based on the automatically determined user preferences; and
downloading at least some of the items of content to the user device according to the prioritization of the items of content.
